(19) United States
(12) Patent Application Publication
(10) Pub. No.: US 2024/0065471 A1
(43) Pub. Date: Feb. 29, 2024

(54) APPARATUS FOR EXTRACTING BEVERAGE

(71) Applicant: SAMSUNG ELECTRONICS CO., LTD., Suwon-si (KR)

(72) Inventors: Geunyong PARK, Suwon-si (KR); Myoungkeun KWON, Suwon-si (KR); Sojeong YU, Suwon-si (KR); Hyunjoon CHOO, Suwon-si (KR)

(21) Appl. No.: 18/360,809

(22) Filed: Jul. 28, 2023

Related U.S. Application Data
(63) Continuation of application No. PCT/KR2023/009311, filed on Jul. 3, 2023.

(30) Foreign Application Priority Data
Aug. 30, 2022 (KR) 10-2022-0109292
Oct. 17, 2022 (KR) 10-2022-0133608

(51) Int. Cl. A47J 31/44; A47J 31/057; A47J 31/46

(52) U.S. Cl. CPC A47J 31/4478; A47J 31/0573; A47J 31/46

(57) ABSTRACT

Provided is a beverage extraction apparatus including a water tank for storing water, a heater configured to heat the water supplied from the water tank, and a water distribution module configured to discharge the heated water toward the dripper from a plurality of locations. The water distribution module includes a water outlet member including a water outlet plate and a plurality of water outlets provided to pass through the water outlet plate, and the water distribution module is configured such that discharge times at which water begins to be discharged from the plurality of water outlets are different.

### CROSS-REFERENCE TO RELATED APPLICATIONS

This application is a continuation application of International Application No. PCT/KR2023/009311 designating the United States, filed on Jul. 3, 2023, in the Korean Intellectual Property Receiving Office and claiming priority to Korean Patent Application No. 10-2022-0109292, filed on Aug. 30, 2022, and Korean Patent Application No. 10-2022-0133608, filed on Oct. 17, 2022, in the Korean Intellectual Property Office, the disclosures of which are incorporated by reference herein in their entireties.

### TECHNICAL FIELD

The disclosure provides a beverage extraction apparatus.

### BACKGROUND ART

A beverage may be extracted by supplying heated water to a dripper with an extractable beverage target placed therein. For example, coffee in a liquid form (liquid coffee) may be extracted by supplying heated water to a dripper with a filter having placed therein coffee powder obtained by grinding coffee beans. The coffee extracted in this way is called drip coffee, and in some cases may be called pour-over coffee, filtered coffee, or brewed coffee.

As a method of extracting such drip coffee, a hand drip method where a person directly adjusts water by using a drip port is typically used. However, in this hand drip method, the speed at which water is poured, the way of pouring water, temperature of water, etc. vary depending on the person making the coffee, and the speed, the way of pouring, temperature of the water, etc. may not be consistent even for the same person. Accordingly, the quality of the extracted coffee may not be consistent.

To overcome the drawback of the hand drip method, the use of a beverage extraction apparatus that automatically pours water into a dripper and extracts a beverage, such as coffee, may be considered.

### DESCRIPTION OF EMBODIMENTS

### Solution to Problem

A beverage extraction apparatus according to an embodiment of the disclosure may be an apparatus for extracting a beverage by discharging heated water toward a dripper.

According to an embodiment of the disclosure, the beverage extraction apparatus includes a water tank for storing water, a heater configured to heat the water supplied from the water tank, and a water distribution module configured to discharge the heated water toward the dripper from a plurality of locations.

According to an embodiment of the disclosure, the water distribution module of the beverage extraction apparatus may include a pipe member configured to provide at least one flow path for receiving the heated water, and a water outlet member including a water outlet plate and a plurality of water outlets provided to pass through the water outlet plate.

The water distribution module may be configured such that discharge times at which water begins to be discharged from the plurality of water outlets are different.

The water distribution module may be configured such that at least one of diameters of the plurality of water outlets or lengths of paths along which water supplied from the pipe member moves until it is discharged through the plurality of water outlets is different.

### BRIEF DESCRIPTION OF DRAWINGS

FIG. 1 illustrates a beverage extraction apparatus according to an embodiment of the disclosure.

FIG. 2 is a conceptual view of a beverage extraction apparatus according to an embodiment of the disclosure.

FIG. 3A is an assembled perspective view of a water distribution module according to an embodiment of the disclosure, and FIG. 3B is an exploded perspective view of the water distribution module according to an embodiment of the disclosure.

FIG. 4 is a cross-sectional view of the water distribution module of FIG. 3A, taken along line A-A′.

FIG. 5 is a cross-sectional view of the water distribution module of FIG. 3A, taken along line B-B′.

FIG. 6 is a plan view illustrating an example of a water outlet member according to an embodiment of the disclosure.

FIG. 7 is a partial bottom perspective view of an example of a water outlet member, according to the embodiment of FIG. 6.

FIG. 8 is a cross-sectional perspective view of a part of the water outlet member of FIG. 7.

FIG. 9 is a perspective view showing an example of a water outlet member according to an embodiment of the disclosure.

FIG. 10 is a plan view illustrating a path of movement of water in the water outlet member of FIG. 9.

FIG. 11 is a perspective view showing an example of a water outlet member according to an embodiment of the disclosure.

FIG. 12 is a cross-sectional view of the water outlet member of FIG. 11.

FIG. 13 is an assembled perspective view of a water distribution module according to an embodiment of the disclosure.

FIG. 14 is an exploded perspective view of the water distribution module according to an embodiment of the disclosure.

FIG. 15 is a cross-sectional view of the water distribution module taken along line C-C′ of FIG. 13.

FIG. 16 is a perspective view for explaining an operation of a water outlet member of FIG. 13.

FIG. 17 is a cross-sectional view of the water outlet member of FIG. 16.

FIG. 18 is an exploded perspective view of a water distribution module including a water outlet member, according to an embodiment of the disclosure.

FIG. 19 is a perspective view of a water outlet plate according to an embodiment of the disclosure.

FIG. 20 is an enlarged view of a portion of the water outlet plate of FIG. 19.

FIG. 21 is a view for explaining a beverage extraction apparatus according to an embodiment of the disclosure.

FIG. 22 is a view for explaining a power supply structure of the beverage extraction apparatus of FIG. 21.

### MODE OF DISCLOSURE

Throughout the disclosure, the expression “at least one of a, b or c” indicates only a, only b, only c, both a and b, both a and c, both b and c, all of a, b, and c, or variations thereof. “At least one” is not to be construed as limiting “a” or “an.” “Or” means “and/or.” As used herein, the term “and/or” includes any and all combinations of one or more of the associated listed items.

Embodiments of the disclosure will be described more fully with reference to the accompanying drawings. In the drawings, like reference numerals or symbols refer to like components or elements performing substantially the same functions.

It will be understood that, although the terms including an ordinal number such as “first”, “second”, etc. may be used herein to describe various elements or components, these elements or components should not be limited by the terms. The terms are only used to distinguish one element or component from another element or component. For example, as used herein, a first element or component may be termed a second element or component without departing from the scope of the disclosure, and similarly, a second element or component may be termed a first element or component. As used herein, the term “and/or” includes any and all combinations of one or more of the associated listed items.

The terms used herein are for the purpose of describing an embodiment of the disclosure and is not intended to limit the disclosure. As used herein, singular forms are intended to include the plural forms as well, unless the context clearly indicates otherwise. It will be further understood that the terms “comprises” and/or “includes” when used in this specification, specify the presence of stated features, numbers, steps, operations, elements, components, or combinations thereof, but do not preclude the presence or addition of one or more other features, numbers, steps, operations, elements, components, or combinations thereof. In the drawings, like reference numerals represent like elements performing substantially the same functions.

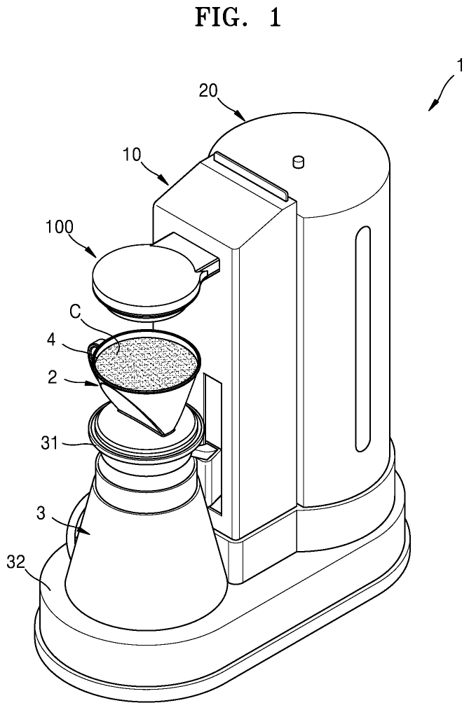

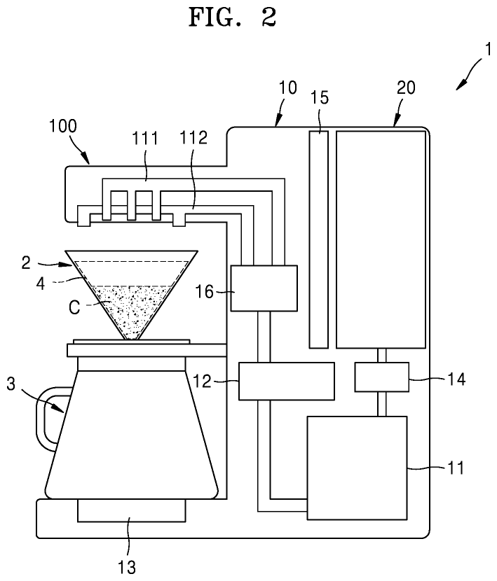

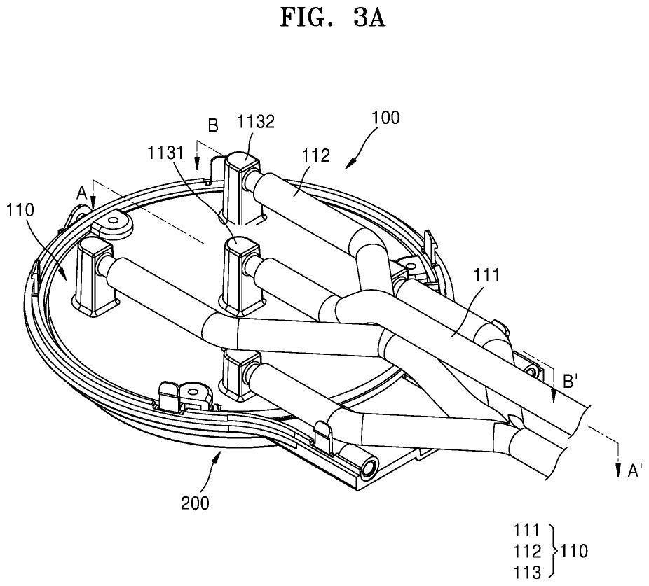

FIG. 1 illustrates a beverage extraction apparatus 1 according to an embodiment of the disclosure, and FIG. 2 is a conceptual view of the beverage extraction apparatus 1 according to an embodiment of the disclosure.

Referring to FIGS. 1 and 2, according to an embodiment of the disclosure, the beverage extraction apparatus 1 is an apparatus for extracting a beverage by discharging heated water toward a dripper 2. For example, the beverage extraction apparatus 1 may be an apparatus for extracting a coffee beverage (hereinafter, referred to as ‘coffee’) by pouring heated water onto an extractable target, such as coffee powder C, contained in the dripper 2.

As an example for the apparatus, the beverage extraction apparatus 1 may include a water tank 20 for storing water, a heater 11 for heating the water, and a water distribution module 100 for pouring water into the dripper 2 in which the coffee powder C may be put.

The dripper 2 may have a structure with a width or a diameter decreasing toward a bottom thereof, for example, an inverted cone shape, and a filter 4 may be provided in the dripper 2. The coffee powder C may be contained in the filter 4. A server 3 for storing extracted coffee may be provided below the dripper 2.

The water tank 20 may be detachably mounted to a main body 10 and store water. A user may detach the water tank 20 from the main body 10 to fill the water tank 20 with water or clean the inside thereof.

A heater 11 may be provided between the water tank 20 and the water distribution module 100 and heat water supplied from the water tank 20. For example, the heater 11 may be disposed between the water tank 20 and the water distribution module 100 in view of a water flow path. The heater 11 may heat the water to a set target temperature. An operation time and an operation start time of the heater 11 may be controlled by a controller 15. The target temperature to which the heater 11 heats the water may vary depending on a type of the extractable target, such as the coffee powder C, extraction time, etc.

The water distribution module 100 may be configured to discharge heated water toward the dripper 2 from a plurality of locations. As the water is discharged from the plurality of locations by the water distribution module 100, the water is poured onto the coffee powder C contained in the dripper 2, and then coffee is extracted. The extracted coffee is then stored in the server 3.

According to an embodiment of the disclosure, the beverage extraction apparatus 1 may further include a pump 12 for providing pressure so that the water stored in the water tank 20 is directed toward the water distribution module 100. The controller 15 may control the pump 12 to adjust at least one of a discharge speed or a discharge time at which water is discharged by the water distribution module 100.

According to an embodiment of the disclosure, the beverage extraction apparatus 1 may further include a dripper holder 31 on which the dripper 2 is placed and a server holder 32 on which the server 3 is mounted. The dripper holder 31 may have a vertically movable structure. The user may adjust a height of the dripper 2 according to a size of the server 3 or the dripper 2 by adjusting a height of the dripper holder 31. A container detection sensor 13 may be provided in the server holder 32 and detect whether the server 3 is mounted. The controller 15 may determine whether the pump 12 operates based on a result of the detection by the container detection sensor 13.

According to an embodiment of the disclosure, the beverage extraction apparatus 1 may further include a flow sensor 14 for detecting a flow rate of water supplied from the water tank 20. The flow sensor 14 may be provided between the water tank 20 and the heater 11. However, arrangement of the flow sensor 14 is not limited thereto, and may be variously changed as long as the flow sensor 14 is positioned to detect the amount of water supplied.

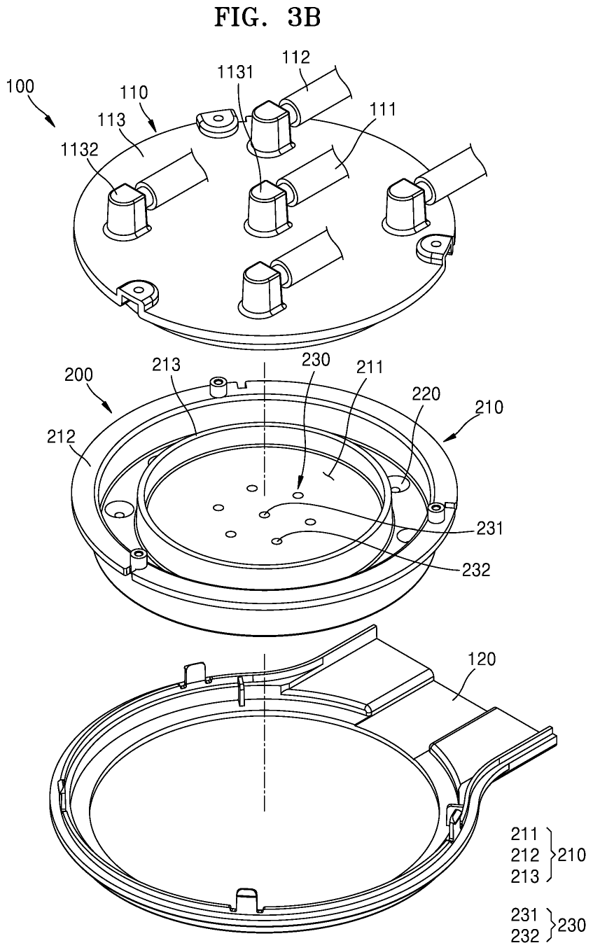

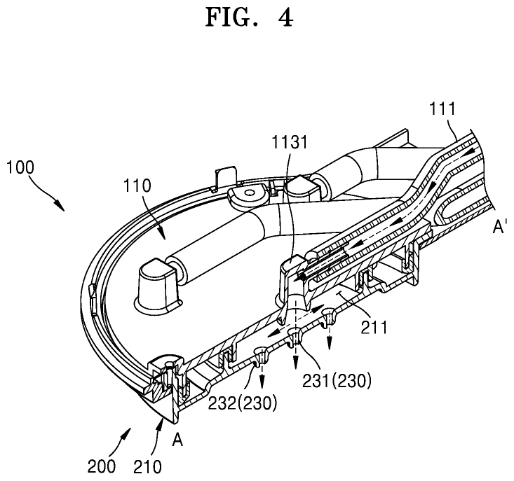

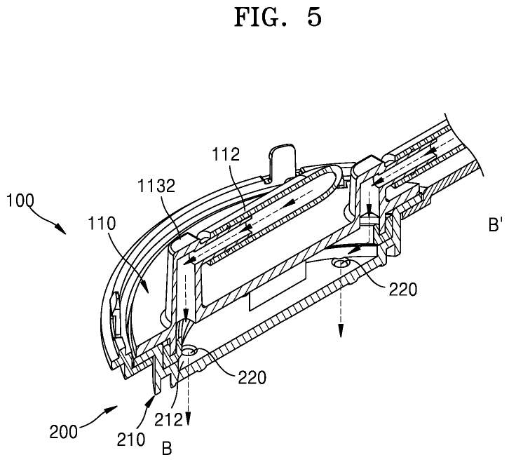

FIG. 3A is an assembled perspective view of the water distribution module 100 according to an embodiment of the disclosure, and FIG. 3B is an exploded perspective view of the water distribution module 100 according to an embodiment of the disclosure. FIG. 4 is a cross-sectional view of the water distribution module 100 of FIG. 3A taken along line A-A′, and FIG. 5 is a cross-sectional view of the water distribution module 100 of FIG. 3A taken along line B-B′. For convenience of description, a housing for covering an upper portion of a pipe member 110 in the water distribution module 100 is not shown in FIGS. 3A and 3B.

Referring to FIGS. 3A and 3B, according to an embodiment of the disclosure, the water distribution module 100 may be configured to discharge heated water toward the dripper 2. For example, the water distribution module 100 may include the pipe member 110 for providing at least one flow path for receiving heated water, and a water outlet member 200 configured to allow water supplied from the pipe member 110 to be discharged through a plurality of locations.

The pipe member 110 may be configured to supply water heated by the heater 11 to a plurality of regions of the water outlet member 200. For example, the pipe member 110 may include a first pipe 111 for supplying water to a first region of the water outlet member 200, e.g., a central region 211 of a water outlet plate 210, and a second pipe 112 for supplying water to a second region of the water outlet member 200, e.g., an outer region 212 of the water outlet plate 210.

The pipe member 110 may include a pipe plate 113 provided above the water outlet member 200. The pipe plate 113 may include a first connector 1131 connected to the first pipe 111 and a second connector 1132 connected to the second pipe 112. The first connector 1131 may be provided to overlap the central region 211 of the water outlet plate 210, and the second connector 1132 may be disposed to overlap the outer region 212 of the water outlet plate 210. The second connector 1132 may be configured as a plurality of second connectors 1132.

The first pipe 111 may be provided to supply water to the central region 211 of the water outlet plate 210. The first pipe 111 may be connected to the first connector 1131 of the pipe plate 113. A first flow path through which water (e.g., heated water) moves toward the central region 211 of the water outlet plate 210 may be provided by the first pipe 111 and the first connector 1131. The water moving through the first flow path may be supplied to the coffee powder C contained in the dripper 2. The first pipe 111 or the first connector 1131 may be provided in a singular number. However, the number of the first pipe 111 or the first connector 1131 is not limited thereto, and the first pipe 111 or the first connector 1131 may be provided in a multiple number in another embodiment.

The second pipe 112 may be provided to supply water to the outer region 212 of the water outlet plate 210. For example, the second pipe 112 may be configured as a plurality of second pipes 112. The plurality of second pipes 112 may be connected to the plurality of second connectors 1132 of the pipe plate 113, respectively. The plurality of second pipes 112 may supply water to the outer region 212 of the water outlet plate 210 at regular intervals via the second connectors 1132. A second flow path through which water moves toward the outer region 212 of the water outlet plate 210 may be provided by the second pipe 112 and the second connector 1132. Water moving through the second fluid path may be supplied to the filter 4 in the dripper 2. The second fluid path may be a passage through which rinsing water for rinsing the filter 4 moves. The number and connection structure of the second pipes 112 and the second connectors 1132 according to the embodiment of the disclosure are merely an example, and are not necessarily limited thereto.

The second pipe 112 and the first pipe 111 may be connected by a valve (16 of FIG. 2). The valve 16 may be a 3-way valve. The heated water may be selectively supplied to the first pipe 111 or the second pipe 112 by the valve 16. For example, in a rinsing operation for wetting the filter 4, the valve 16 may open the second pipe 112 while blocking the first pipe 111, so that water is supplied via the second pipe 112. In a drip operation for extracting coffee, the valve 16 may open the first pipe 111 while blocking the second pipe 112, so that water is supplied via the first pipe 111.

The water outlet member 200 may include a water outlet plate 210 and a plurality of water outlets 220 and 230 provided to pass through the water outlet plate 210.

The water outlet plate 210 may include the central region 211, the outer region 212, and a border wall 213 for separating the central region 211 from the outer region 212. The border wall 213 has a ring shape and prevents water from moving between the central region 211 and the outer region 212. The water outlet plate 210 may be supported on the main body 10 by a support 120.

The plurality of water outlets 220 and 230 may include a plurality of drip water outlets 230 provided in the central region 211 and a plurality of rinsing water outlets 220 provided in the outer region 212.

Referring to FIGS. 3A, 3B, and 4, the plurality of drip water outlets 230 may be provided at or around a center of the water outlet plate 210. The plurality of drip water outlets 230 may include a central water outlet 231 provided at the center and a plurality of peripheral water outlets 232 provided around the central water outlet 231. However, arrangement of the plurality of drip water outlets 230 is not limited thereto, and may vary. For another example, the plurality of drip water outlets 230 may include the plurality of peripheral water outlets 232 without the central water outlet 231.

Water is supplied to the central region 211 of the water outlet plate 210 via the first pipe 111 and the first connector 1131 of the pipe member 110, and the supplied water may be discharged from a plurality of locations through the plurality of drip water outlets 230. The water discharged from the plurality of locations falls over the coffee powder C contained in the dripper 2, and then coffee may be extracted.

Referring to FIGS. 3A, 3B, and 5, the plurality of rinsing water outlets 220 may be provided in the outer region 212 at regular intervals along a circumferential direction. Each of the plurality of rinsing water outlets 220 may have the same diameter. Each of the plurality of rinsing water outlets 220 may have a larger diameter than a diameter of each of the plurality of drip water outlets 230. A distance between the plurality of rinsing water outlets 220 may be greater than a distance between the plurality of drip water outlets 230.

A rinsing operation for rinsing the filter 4 may be performed by using the plurality of rinsing water outlets 220 before placing the coffee powder C in the dripper 2. Water supplied to the outer region 212 of the water outlet plate 210 via the second pipe 112 may be discharged from the plurality of locations through the plurality of rinsing water outlets 220. The water discharged from the plurality of locations falls into the filter 4, and then the filter 4 may be rinsed with the water in the rinsing operation. However, because the rinsing operation is optional, it may be omitted according to a user's selection or setting.

According to an embodiment of the disclosure, in the water distribution module 100, the water outlet member 200 may be configured such that discharge times at which water begins to be discharged from the plurality of drip water outlets 230 (hereinafter, referred to as water outlets 230) are different.

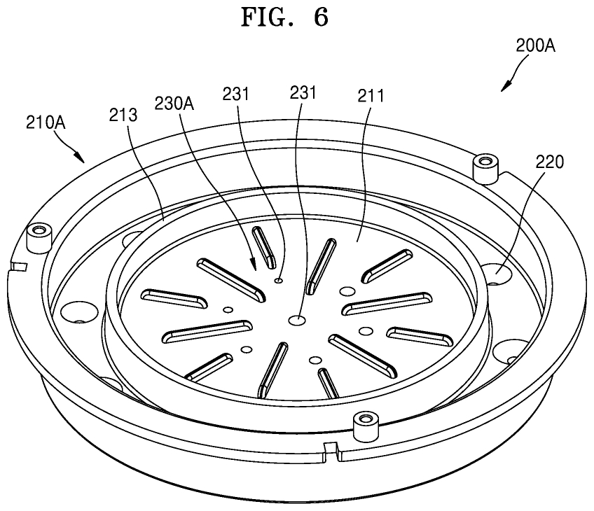

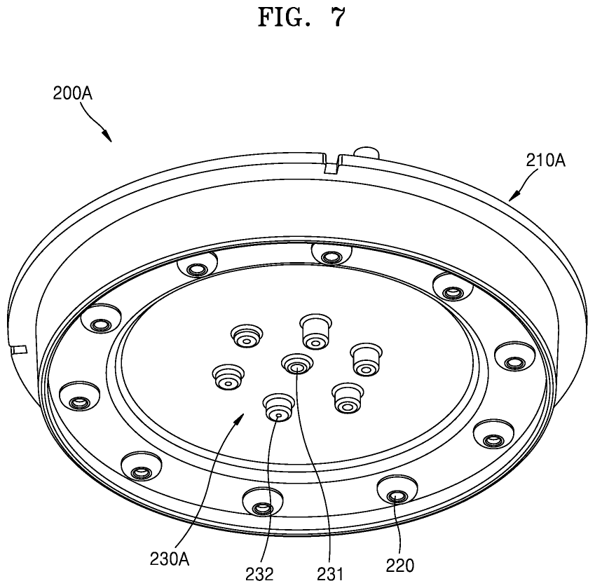

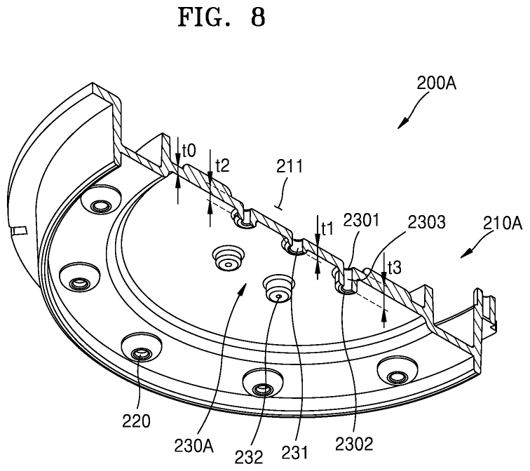

FIG. 6 is a plan view illustrating an example of a water outlet member 200A according to an embodiment of the disclosure. FIG. 7 is a partial bottom perspective view of an example of the water outlet member 200A, according to the embodiment of FIG. 6. FIG. 8 is a cross-sectional perspective view of a part of the water outlet member 200A of FIG. 7.

Referring to FIG. 6, according to an embodiment of the disclosure, the water outlet member 200A includes a water outlet plate 210A having a plurality of water outlets 230A provided in a central region 211.

The plurality of water outlets 230A may include a plurality of peripheral water outlets 232 spaced apart from a center of the water outlet member 200A. For example, the plurality of peripheral water outlets 232 may each be at a constant distance from the center of the water outlet member 200A. As another example, the plurality of peripheral water outlets 232 may be at different distances from the center of the water outlet member 200A. In this case, for example, the plurality of peripheral water outlets 232 may be arranged in a spiral shape.

The plurality of water outlets 230A may further include a central water outlet 231 provided at the center of the water outlet member 200A. However, the central water outlet 231 may be an optional component and may be omitted.

The plurality of water outlets 230A may have different diameters. Due to the difference in diameter, discharge times at which water is discharged from the plurality of water outlets 230A may vary. For example, water may be discharged first from the water outlet 230A having the largest diameter, and water may be discharged last from the water outlet 230A having the smallest diameter.

At least some of the plurality of water outlets 230A may have different diameters. For example, the central water outlet 231 may have a different diameter than a diameter of each of the plurality of peripheral water outlets 232. For example, the central water outlet 231 may have a larger diameter than a diameter of each of the plurality of peripheral water outlets 232. Accordingly, water supplied to the central region 211 of the water outlet member 200A may be discharged from the central water outlet 231 earlier than from the peripheral water outlets 232.

For another example, at least some of the plurality of peripheral water outlets 232 may have different diameters from each other. For example, diameters of the plurality of peripheral water outlets 232 may vary along a clockwise or counter-clockwise direction. For example, the plurality of peripheral water outlets 232 may have decreasing diameters in a clockwise direction. In this case, water supplied to the central region 211 of the water outlet member 200A may be discharged from the plurality of peripheral water outlets 232 sequentially in the clockwise direction.

Although in the embodiment of the disclosure, it has been described mainly with respect to an example in which the plurality of water outlets 230A each have a different diameter, the disclosure is not necessarily limited thereto, and some of the plurality of water outlets 230A may have the same diameter in another embodiment.

Referring to FIGS. 7 and 8, each of the plurality of water outlets 230A may include an inlet port 2301 through which water is introduced, a discharge port 2302 through which water is discharged, and an outlet passage 2303 connecting the inlet port 2301 with the discharge port 2302. A thickness of each water outlet 230A may vary depending on a length t3 of the outlet passage 2303. The length of the outlet passage 2303 may be a length of water discharge through the water outlet 230A. The thickness of the water outlet 230A may be a thickness along a direction in which the water is discharged therethrough.

At least some of the plurality of water outlets 230A may have different lengths of water discharge. For example, the plurality of water outlets 230A may have different lengths of water discharge from each other. The plurality of water outlets 230A may have different thicknesses along a direction in which water is discharged therefrom so that lengths of water discharge vary. When the plurality of water outlets 230A have different lengths of water discharge, times at which water is discharged through the plurality of water outlets 230A may vary. For example, the shorter the length of water discharge, the earlier the discharge time at which water is discharged, and the longer the length of water discharge, the later the discharge time at which water is discharged.

For example, the central water outlet 231 may have a different length of water discharge than a length of each of the peripheral water outlets 232. For example, a thickness t1 of the central water outlet 231 may be less than a thickness t2 of each of the peripheral water outlets 232. Accordingly, water supplied to the central region 211 of the water outlet member 200A may be discharged from the central water outlet 231 earlier than from the peripheral water outlets 232.

For example, at least some of the plurality of peripheral water outlets 232 may have different lengths of water discharge. The plurality of peripheral water outlets 232 may have different lengths of water discharge. For example, the plurality of peripheral water outlets 232 may have different thicknesses t2. For example, thicknesses t2 of the plurality of peripheral water outlets 232 may vary along a clockwise or counter-clockwise direction. For example, the plurality of peripheral water outlets 232 may have increasing thicknesses t2 in a counter-clockwise direction. That is, the plurality of peripheral water outlets 232 may have decreasing thicknesses t2 in a clockwise direction. In this case, water supplied to the central region 211 of the water outlet member 200A may be discharged from the plurality of peripheral water outlets 232 sequentially in the counter-clockwise direction.

The thicknesses t2 of at least some of the plurality of water outlets 230A may each be greater than a thickness t0 of the water outlet plate 210A. For example, the at least some of the plurality of water outlets 230A may each have a structure protruding from the water outlet plate 210A. For example, the water outlet 230A may have a shape of a column protruding from the water outlet plate 210A along the direction in which water is discharged.

A length of water discharge through the water outlet 230A may be determined by taking into account a diameter of the water outlet 230A. For example, the water outlet 230A having the largest diameter among the plurality of water outlets 230A may have the shortest length of water discharge. For example, the central water outlet 231 may have the largest diameter and the shortest length of water discharge among the plurality of water outlets 230A. For example, the water outlet 230A having the smallest diameter among the plurality of water outlets 230A may have the longest length of water discharge. For example, one of the peripheral water outlets 232 may have the smallest diameter and the longest length of water discharge. Accordingly, water supplied to the central region 211 of the water outlet member 200A begins to be discharged first from the central water outlet 231 and last from one of the peripheral water outlets 232 which has the smallest diameter and the longest length of water discharge. However, because the structure of the plurality of water outlets 230A is merely an example, it is not limited thereto and may be appropriately changed to adjust the discharge time at which water is discharged.

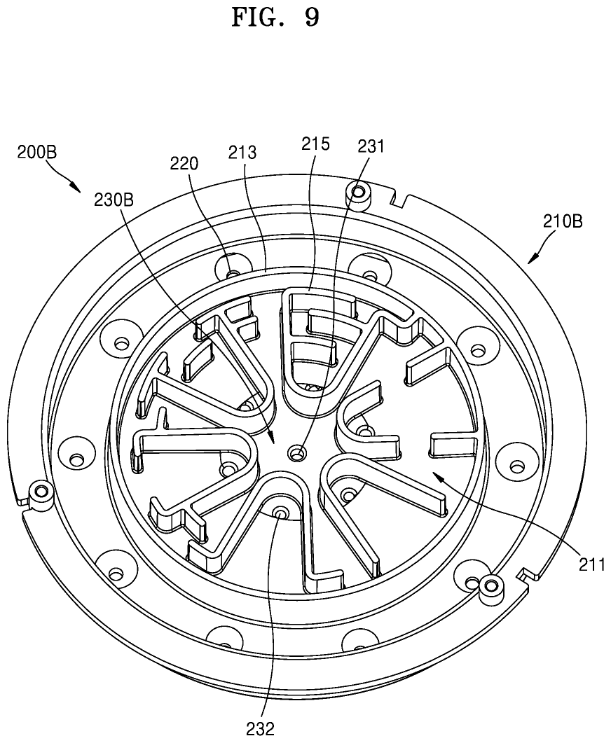

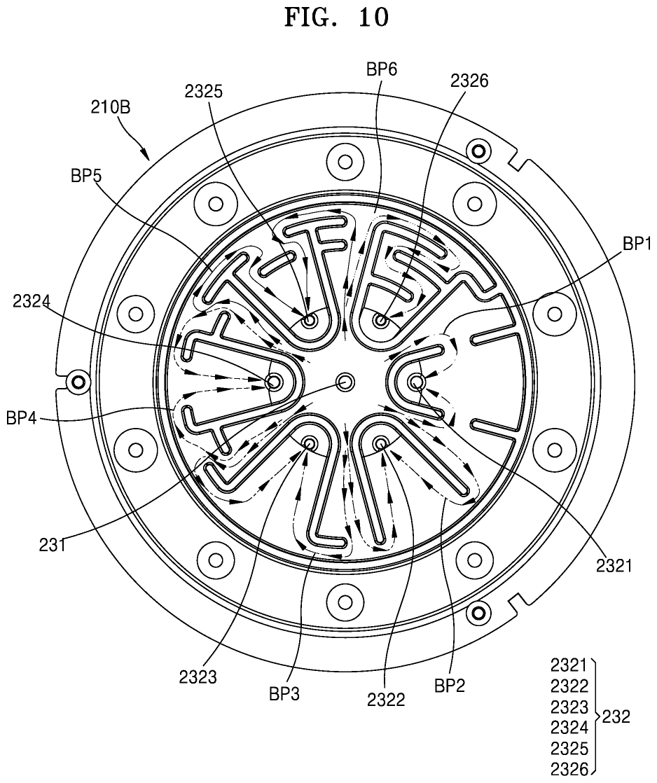

FIG. 9 is a perspective view showing an example of a water outlet member 200B according to an embodiment of the disclosure, and FIG. 10 is a plan view illustrating a path of movement of water in the water outlet member 200B of FIG. 9.

Referring to FIG. 9, according to an embodiment of the disclosure, the water outlet member 200B may include a water outlet plate 210B having a plurality of water outlets 230B in a central region 211. The plurality of water outlets 230B may include a plurality of peripheral water outlets 232 spaced apart from a center of the water outlet member 200B and arranged along a circumferential direction. The plurality of peripheral water outlets 232 may each be at a constant distance from the center of the water outlet member 200B. However, arrangement of the plurality of peripheral water outlets 232 is not limited thereto and may vary. For another example, although not shown in FIG. 9, the plurality of peripheral water outlets 232 may be at different distances from the center of the water outlet member 200B.

Water supplied from the pipe member (110 of FIG. 4) may fall within a certain radius from the center of the water outlet member 200B such that the water does not fall directly into the plurality of peripheral water outlets 232. For example, water supplied from the pipe member 110 may fall more radially inward than the plurality of peripheral water outlets 232.

In the water outlet member 200B, paths through which the water supplied from the pipe member 110 moves to the plurality of water outlets 230B may have different lengths from each other such that discharge times at which the water begins to be discharged from the plurality of water outlets 230B are different. For example, the water outlet plate 210B may include a guide wall 215 for guiding a flow path of water along a top surface of the central region 211 of the water outlet plate 210B such that a path along which water supplied from the pipe member 110 moves toward each of the plurality of peripheral water outlets has different lengths.

The guide wall 215 may protrude from the water outlet plate 210B in a direction opposite to a direction in which water is discharged. The guide wall 215 may protrude from the top surface of the central region 211 of the water outlet plate 210B. The guide wall 215 may extend continuously or discontinuously in a radial direction of the water outlet plate 210B and in a circumferential direction perpendicular to the radial direction. However, a planar shape of the guide wall 215 is not limited thereto, and may vary depending on a length of a path along which the water moves toward each of the peripheral water outlets 232.

Referring to FIG. 10, the guide wall 215 may provide a bypass path so that water supplied from the pipe member 110 does not move directly to each of the plurality of peripheral water outlets 232. Bypass paths for the plurality of peripheral water outlets 232 provided by the guide wall 215 may be of different lengths. For example, the guide wall 215 may provide a first bypass path BP1 for a first peripheral water outlet 2321, a second bypass path BP2 for a second peripheral water outlet 2322, a third bypass path BP3 for a third peripheral water outlet 2323, a fourth bypass path BP4 for a fourth peripheral water outlet 2324, a fifth bypass path BP5 for a fifth peripheral water outlet 2325, and a sixth bypass path BP6 for a sixth peripheral water outlet 2326. The plurality of bypass paths may have lengths that are sequentially increasing or decreasing. For example, the first bypass path BP1 may have the shortest length and the sixth bypass path BP6 may have the longest length. Accordingly, water may begin to be discharged sequentially from the first peripheral water outlet 2321, the second peripheral water outlet 2322, the third peripheral water outlet 2323, the fourth peripheral water outlet 2324, the fifth peripheral water outlet 2325, and the sixth peripheral water outlet 2326. However, the order of discharge times at which water are discharged from the plurality of peripheral water outlets 232 may vary depending on a shape of the guide wall 215.

The plurality of water outlets 230B may include at least one central water outlet 231 provided at the center. In the water outlet plate 210B, a length of a path along which water supplied from the pipe member 110 moves toward the central water outlet 231 may be less than a length of a path along which water supplied from the pipe member 110 moves toward each of the peripheral water outlets 232. Accordingly, water may begin to be discharged from the central water outlet 231 and then sequentially discharged from the plurality of peripheral water outlets 232.

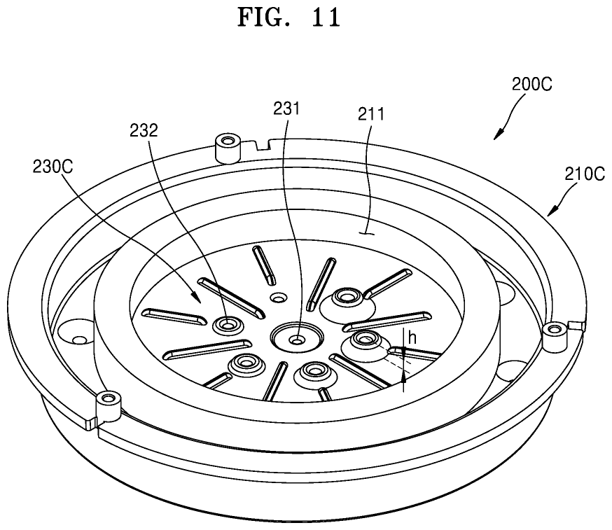

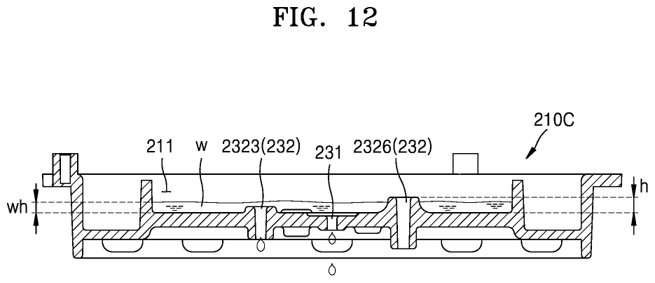

FIG. 11 is a perspective view showing an example of a water outlet member 200C according to an embodiment of the disclosure, and FIG. 12 is a cross-sectional view of the water outlet member 200C of FIG. 11.

Referring to FIG. 11, according to an embodiment of the disclosure, the water outlet member 200C may include a water outlet plate 210C having a plurality of water outlets 230C in a central region 211. The plurality of water outlets 230C may include a plurality of peripheral water outlets 232 spaced apart from a center of the water outlet member 200C and arranged along a circumferential direction. The plurality of water outlets 230C may include at least one central water outlet 231 provided at the center.

At least some of the plurality of water outlets 230C may have different protrusion heights h to which they protrude in a direction opposite to the direction in which water is discharged. The plurality of water outlets 230C may have different protrusion heights h to which they protrude in a direction opposite to the direction in which water is discharged. For example, the central water outlet 231 may have a different protrusion height h than a protrusion height h of each of the plurality of peripheral water outlets 232. At least some of the plurality of peripheral water outlets 232 may have different protrusion heights h from each other. For example, the plurality of peripheral water outlets 232 may have different protrusion heights h. Here, a protrusion height h of the peripheral water outlet 232 may be represented as a positive (+) number when the peripheral water outlet 232 protrudes upward from a top surface of the central region 211 of the water outlet plate 210C, represented as 0 when an upper surface of the peripheral water outlet 232 coincides with the top surface of the central region 211 of the water outlet plate 210C, and represented as a negative (−) number when the peripheral water outlet 232 is recessed from the top surface of the central region 211 of the water outlet plate 210C.

When the plurality of water outlets 230C have different protrusion heights h, times at which water is introduced into the plurality of water outlets 230C may vary. Accordingly, times at which water begins to be discharged through the plurality of water outlets 230C may vary.

Referring to FIG. 12, as water w is supplied to the central region 211 of the water outlet member 200C, a level wh of the water w may rise. Therefore, the water w may be first introduced into the water outlet 230C having the lowest protrusion height h among the plurality of water outlets 230C, and then the water w may begin to be discharged from the corresponding water outlet 230C.

For example, as the water w is supplied to the central region 211 of the water outlet member 200C, a level wh of the water w filled in the central region 211 of the water outlet member 200C may rise. When the level wh of the water w rises above a protrusion height h of the central water outlet 231, the water w is introduced into the central water outlet 231 and then begins to be discharged therefrom in a case that the protrusion height h of the central water outlet 231 is the lowest among the water outlets 230C. In this case, the water w is not introduced into the plurality of peripheral water outlets 232 and thus is not discharged therefrom. Then, when the level wh of the water w rises above a protrusion height h of one peripheral water outlet 2323, the water w is introduced into the peripheral water outlet 2323 and begins to be discharged therefrom. Thereafter, when the level wh of the water w rises above a protrusion height h of another peripheral water outlet 2326, the water w is introduced into the other peripheral water outlet 2326 and begins to be discharged therefrom.

Referring back to FIG. 11, the plurality of peripheral water outlets 232 may have different protrusion heights h. For example, the plurality of peripheral water outlets 232 may have increasing protrusion heights h in a clockwise or counter-clockwise direction. For example, the plurality of peripheral water outlets 232 may have increasing protrusion heights h in a counter-clockwise direction. In this case, as the water w is supplied to the central region 211 of the water outlet member 200C so that the level wh of the water w rises, the water w may begin to be discharged from the plurality of peripheral water outlets 232 in the counter-clockwise direction.

On the other hand, when the supply of water w is stopped, the level wh of the water w in the central region 211 of the water outlet member 200C gradually falls. As the water level wh of the water w decreases, discharge of the water w from the water outlet 230C with a maximum protrusion height h is stopped first, and discharge of the water w from the water outlet 230C with a minimum protrusion height h is stopped last. For example, for the plurality of peripheral water outlets 232 with increasing protrusion heights h in the counter-clockwise direction, as shown in FIG. 11, discharge of the water w may be stopped in the clockwise direction. By these structural arrangements, even without a programed separate driving motor in the water distribution module 100, the way of pouring water (e.g., discharging water in a spiral sequence) used by a person skilled in a hand drip method may be implemented with consistency.

Referring to FIGS. 11 and 12, protrusion heights h of the plurality of water outlets 230C may be determined by taking into account a length of water discharge through the plurality of water outlets 230C. For example, a protrusion height h of the plurality of water outlets 230C may be determined to be lower as a length of water discharge is shorter. A protrusion height h of the plurality of water outlets 230C may be determined to be higher as a length of water discharge is longer. For example, the water outlet 230C having the shortest length of water discharge among the plurality of water outlets 230C may have a minimum protrusion height h. For example, the water outlet 230C having the longest water outlet among the plurality of water outlets 230C may have a maximum protrusion height H.

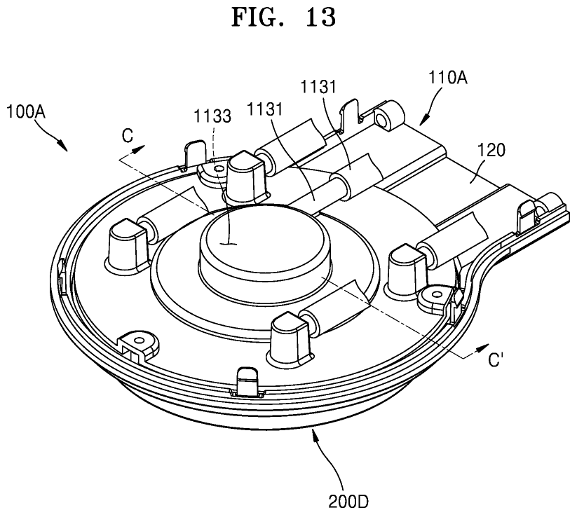

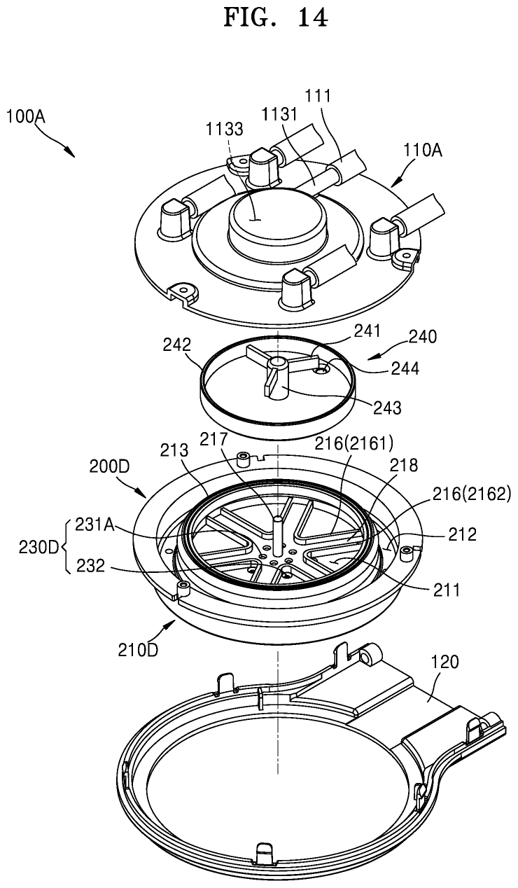

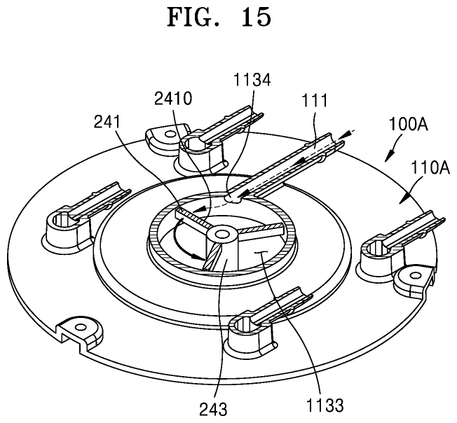

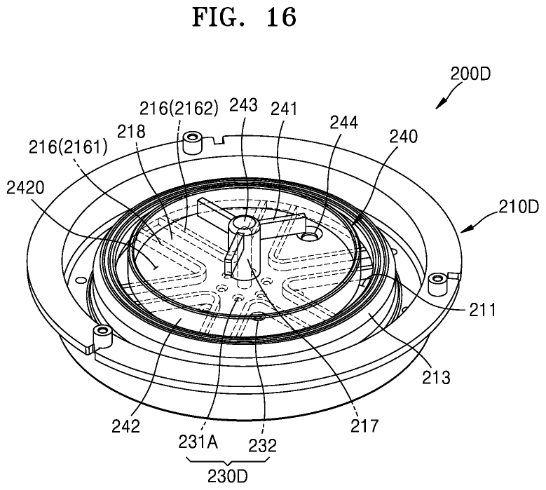

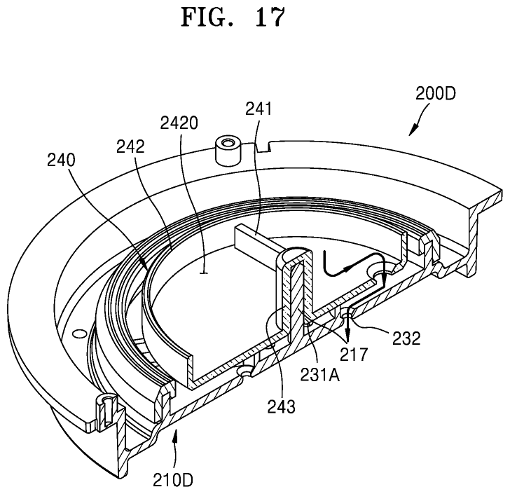

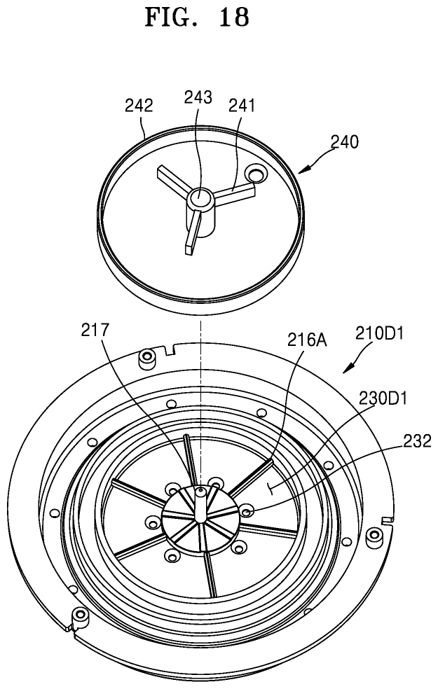

FIG. 13 is an assembled perspective view of a water distribution module 100A according to an embodiment of the disclosure, and FIG. 14 is an exploded perspective view of the water distribution module 100A according to an embodiment of the disclosure. FIG. 15 is a cross-sectional view of the water distribution module 100A taken along line C-C′ of FIG. 13. FIG. 16 is a perspective view for explaining an operation of a water outlet member 200D of FIG. 13, and FIG. 17 is a cross-sectional view of the water outlet member 200D of FIG. 16. FIG. 18 is an exploded perspective view of a water distribution module 100A including a water outlet member 200D, according to an embodiment of the disclosure.

Referring to FIGS. 13 and 14, the water distribution module 100A according to the embodiment of the disclosure includes a water outlet member 200D and a pipe member 110A. The water outlet member 200D may include a water outlet plate 210D having a plurality of water outlets 230D and a blade 240 provided in an upper portion of the water outlet plate 210D. The blade 240 may be rotatable. The pipe member 110A may include a spray hole 1134 through which water is sprayed toward the blade 240. Water may be sprayed toward the blade 240 through the spray hole 1134. The pipe member 110A may provide a space 1133 in which at least a portion of the blade 240 is rotatable.

The blade 240 may include a wing 241 configured to be rotated by water supplied through the pipe member 110A, and a body portion 242 fixed to the wing 241 and configured to rotate together when the wing 241 rotates.

Referring to FIGS. 13 to 15, the pipe member 110A may spray water in a direction perpendicular to a rotation axis of the wing 241. For example, the spray hole 1134 may be provided in a sidewall defining the space 1133 in which the wing 241 is rotatable. Accordingly, water may be sprayed from the spray hole 1134 toward the wing 241 in a horizontal direction perpendicular to the rotational axis.

An inclined surface 2410 of the wing 241 may be perpendicular or tilted with respect to the direction in which the water is sprayed. The blade 240 may include a plurality of wings 241. However, the shape and number of wings 241 are not limited thereto, and may be changed by taking into account a rotation speed required for the blade 240. For example, to increase the rotation speed of the wing 241, the number of wings 241 may be increased. For example, to decrease the rotation speed of the wing 241, the number of wings 241 may be reduced, or a tilt angle for the inclined surface 2410 may be decreased.

The body portion 242 may include a shaft 243 supporting the wing 241. The shaft 243 may be provided at a center of the body portion 242. The body portion 242 provides a temporary storage space 2420 in which water supplied through the pipe member 110A may be temporarily stored before being delivered to the water outlet plate 210D.

The body portion 242 may include a discharge opening 244 through which water is discharged toward some water outlets 230D among the plurality of water outlets 230D. The water temporarily stored in the temporary storage space 2420 of the body portion 242 may be delivered to the water outlet plate 210D via the discharge opening 244.

Referring to FIGS. 15 and 16, the wing 241 is rotated by the water sprayed through the spray hole 1134 of the pipe member 110A. When the wing 241 rotates, the body portion 242 fixed to the wing 241 by the shaft 243 also rotates. Because the water outlet plate 210D does not rotate when the body portion 242 rotates, a location of the discharge opening 244 of the body portion 242 is changed relative to the water outlet plate 210D. When the body portion 242 rotates, a position where the discharge opening 244 overlaps the water outlet plate 210D changes. Thus, water discharged through the discharge opening 244 may be supplied to a different location on the water outlet plate 210D. For example, the water discharged through the discharge opening 244 may be supplied to the plurality of peripheral water outlets 232 sequentially along a direction of rotation of the blade 240. For example, as the blade 240 rotates in a counter-clockwise direction, water may begin to be discharged through the plurality of peripheral water outlets 232 in the counter-clockwise direction.

Referring back to FIGS. 14, 16, and 17, the water outlet plate 210D may include a rotation-support shaft 217 that supports the blade 240 to be rotatable with respect to the water outlet plate 210. The rotation-support shaft 217 may be coaxially provided with respect to the shaft 243 of the blade 240. For example, the shaft 243 of the blade 240 may be rotatably assembled to the rotation-support shaft 217. For example, the rotation-support shaft 217 may be inserted into an internal groove of the shaft 243. In the water outlet plate 210D, a plurality of central water outlets 231A may be provided around the rotation-support shaft 217.

The water outlet plate 210D may have partition walls 216 provided to separate the plurality of water outlets 230D. For example, the partition wall 216 may be provided to surround each of the peripheral water outlets 232. Accordingly, a portion of water discharged around one peripheral water outlet 232 via the discharge opening 244 of the blade 240 may be discharged through the peripheral water outlet 232 without being moved to another peripheral water outlet 232 due to the partition wall 216.

A partition wall 2161 provided to surround the peripheral water outlet 232 may be spaced apart from another partition wall 2162 provided to surround another peripheral water outlet 232 adjacent thereto. A channel 218 through which water may flow may be formed in a space between the partition wall 2161 and the other partition wall 2162. The channel 218 may extend toward the central water outlet 231A. Accordingly, as the blade 240 rotates, another portion of the water is discharged through the discharge opening 244 into the channel 218, and the another portion of the water discharged into the channel 218 may move along the channel 218 and be discharged through the central water outlet 231A. While the portion of water is discharged from the plurality of peripheral outlets 232 in a counter-clockwise direction, the another portion of water may be discharged from the central water outlet 231A.

In this way, water supplied by the pipe member 110A causes the blade 240 to rotate with respect to the water outlet plate 210D, and the water discharged through the discharge opening 244 of the blade 240 that rotates is then delivered to the plurality of water outlets 230D in the water outlet plate 210D at different times. Accordingly, discharge times at which water is discharged from the plurality of water outlets 230D may vary.

While in the embodiment of the disclosure, it has been described mainly with respect to an example in which the water outlet plate 210D has a structure in which the partition walls 216 surrounding the plurality of peripheral water outlets 232, respectively, are spaced apart from each other to form the channel 218, the structure of the water outlet plate 210D and the shape of the blade 240 are not limited thereto. For another example, as shown in FIG. 18, a water outlet plate 210D1 may have a structure in which each of a plurality of peripheral water outlets 232 is surrounded by partition walls 216A without the channel 218 between the plurality of peripheral water outlets 232. In this case, the central water outlet 231A may be omitted.

As described above, in the water outlet member 200D according to the embodiment of the disclosure, paths, along which water supplied from the pipe member 110A moves until it is discharged through the plurality of water outlets 230D, may be designed to have different lengths, so that discharge times at which the water may be discharged from the plurality of water outlets 230D are different. In the water outlet member 200D, at least one of lengths of water discharge through the plurality of water outlets 230D, diameters of the plurality of water outlets 230D, lengths of paths along which water moves to the plurality of water outlets 230D, or protrusion heights of the plurality of water outlets 230D may be designed to be different such that discharge times at which the water is discharged through the plurality of water outlets 230D are different. As an example, one of lengths of water discharge through the plurality of water outlets 230D, diameters of the plurality of water outlets 230D, lengths of paths along which water moves to the plurality of water outlets 230D, or protrusion heights of the plurality of water outlets 230D may be different. For example, only lengths of water discharge through the plurality of water outlets 230D may be different. For example, only diameters of the plurality of water outlets 230D may be different. For example, only lengths of paths along which water moves to the plurality of water outlets 230D may be different. For example, only protrusion heights of the plurality of water outlets 230D may be different. As an another example, two of lengths of water discharge through the plurality of water outlets 230D, diameters of the plurality of water outlets 230D, lengths of paths along which water moves to the plurality of water outlets 230D, or protrusion heights of the plurality of water outlets 230D may be different. As an another example, three of lengths of water discharge through the plurality of water outlets 230D, diameters of the plurality of water outlets 230D, lengths of paths along which water moves to the plurality of water outlets 230D, or protrusion heights of the plurality of water outlets 230D may be different. As an another example, four of lengths of water discharge through the plurality of water outlets 230D, diameters of the plurality of water outlets 230D, lengths of paths along which water moves to the plurality of water outlets 230D, or protrusion heights of the plurality of water outlets 230D may be different. Thus, water may fall over the coffee powder C contained in the dripper 2 at a plurality of locations at different times.

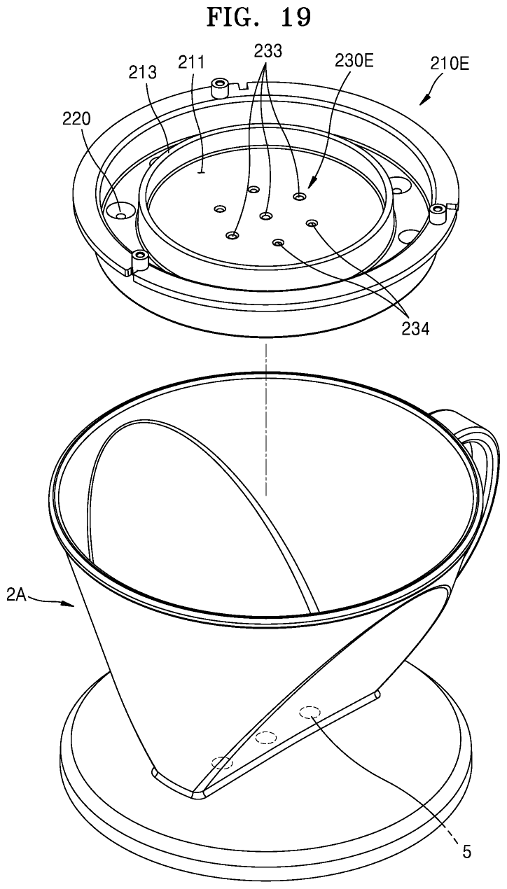

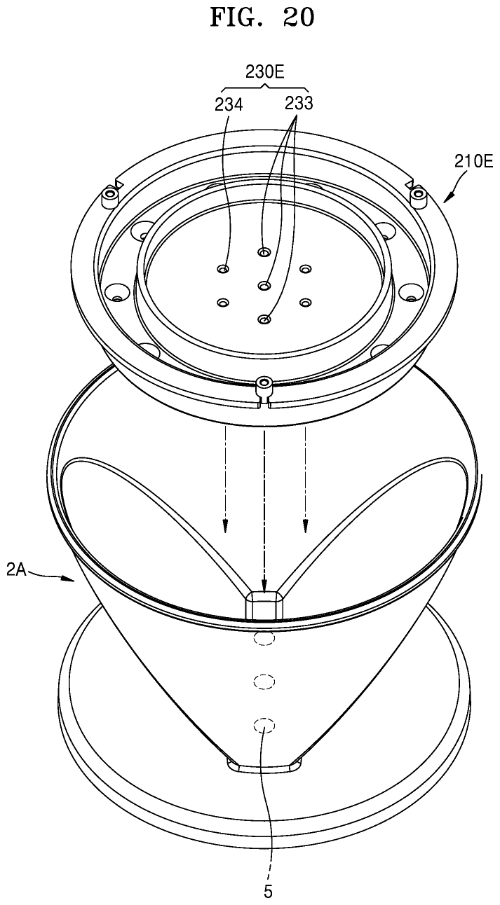

FIG. 19 is a perspective view of a water outlet plate 210E according to an embodiment of the disclosure. FIG. 20 is an enlarged view of a portion of the water outlet plate 210E of FIG. 19.

Referring to FIGS. 19 and 20, the water outlet plate 210E may include a plurality of water outlets 230E provided in a central region 211.

The arrangement of the plurality of water outlets 230E may be determined by taking into account a shape of a dripper 2A. For example, the dripper 2A may have a plurality of drain ports 5 spaced apart along a straight line. The plurality of water outlets 230E of the water outlet plate 210E may also include a plurality of main water outlets 233 spaced apart along an imaginary straight line passing through a center of the water outlet member 200 (specifically, the water outlet plate 211), and a plurality of auxiliary water outlets 234 that are equidistant radially from the center of the water outlet member 200 (specifically, the water outlet plate 211). A diameter of each of the main water outlets 233 may be greater than a diameter of each of the auxiliary water outlets 234. Accordingly, a flow rate of water discharged from the main water outlet 233 may be greater than a flow rate of water discharged from the auxiliary water outlet 234.

When a direction of the dripper 2A is adjusted so that the arrangement direction of the main water outlets 233 coincides with the arrangement direction of the drain ports 5 of the dripper 2A, a relatively large flow rate of water falls through the main water outlets 233 into the coffee powder C provided in a region of the dripper 2A overlapped by the main water outlets 233 while a relatively small flow rate of water falls through the auxiliary water outlets 234 into the coffee powder C provided in a region of the dripper 2A overlapped by the auxiliary water outlets 234. Thus, during coffee extraction, water may be poured from the water outlet plate 210E according to the embodiment of the disclosure to match the amount of coffee powder C contained in the dripper 2A. As described above, in the water outlet member 200 of the beverage extraction apparatus 1 according to the embodiment of the disclosure, at least one of diameters of the plurality of water outlets 230 or lengths of paths along which water supplied from the pipe member 110 moves until it is discharged through the plurality of water outlets 230 may be different. Through these structural arrangement in the water outlet member 200, a discharge time at which water supplied to the dripper 2A is discharged and a flow rate of the discharged water may be adjusted without a separate driving motor.

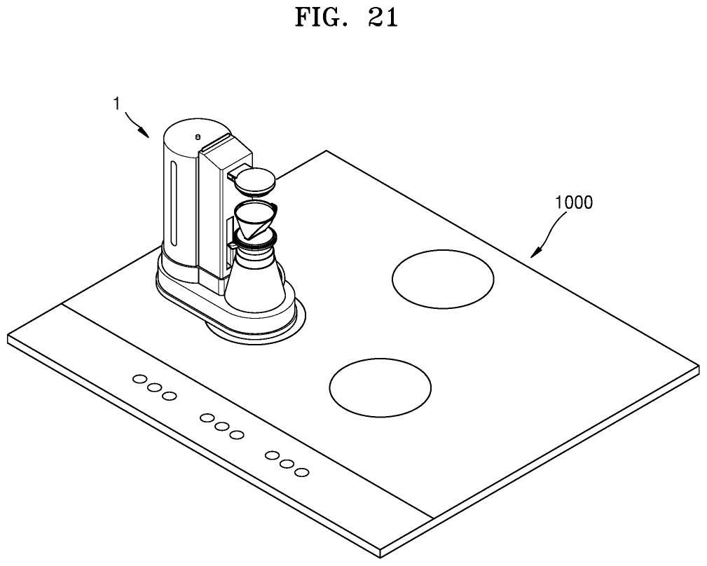

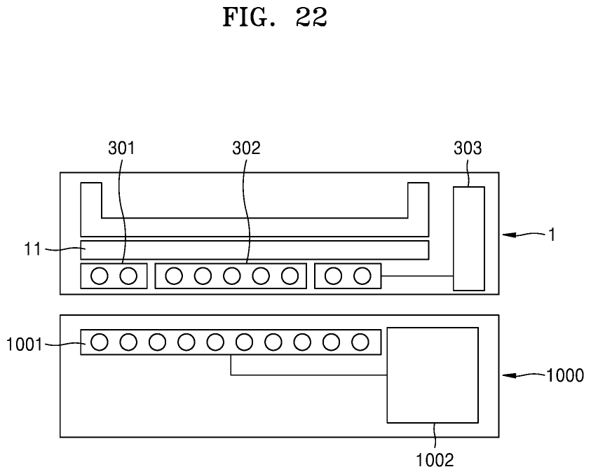

FIG. 21 is a view for explaining the beverage extraction apparatus 1 according to an embodiment of the disclosure. FIG. 22 is a view for explaining a power supply structure of the beverage extraction apparatus 1 of FIG. 21.

Referring to FIGS. 21 and 22, the beverage extraction apparatus 1 according to the embodiment of the disclosure may receive power from a power station 1000. For example, the beverage extraction apparatus 1 may wirelessly receive power from the power station 1000. According to an embodiment of the disclosure, the beverage extraction apparatus 1 may wirelessly receive power from the power station 1000 by using electromagnetic induction. According to an embodiment of the disclosure, the beverage extraction apparatus 1 may not include a power line connected to a power outlet. However, power supply to the beverage extraction apparatus 1 is not necessarily limited to a wireless method, and the beverage extraction apparatus 1 may be supplied with power by a power line in another embodiment.

The power station 1000 may be an apparatus that wirelessly transmits power to an object placed on a top plate, such as the beverage extraction apparatus 1, by using electromagnetic induction. The power station 1000 may be a heating apparatus. The power station 1000 may also be referred to as an induction range or an electric range. The power station 1000 may include a transmission coil 1001 that generates a magnetic field and a printed circuit board (“PCB”) 1002 connected to the transmission coil 1001.

Transmitting power wirelessly may mean transferring power via a reception coil 302 by using a magnetic induction method. For example, the power station 1000 may allow current to flow through the transmission coil 1001 to create a magnetic field so that the magnetic field may be induced in the beverage extraction apparatus 1.

The beverage extraction apparatus 1 may include a pickup coil 301, the reception coil 302, and a PCB 303 for wirelessly receiving power. A communication interface (not shown) and the controller (15 of FIG. 2) may be mounted on the PCB 303.

The pickup coil 301 may receive initial power from the power station 1000. The received initial power may be transferred to the PCB 303. The initial power transferred to the PCB 303 may activate the communication interface and the controller 15. The controller 15 may include at least one processor that may control all operations of the beverage extraction apparatus 1.

The communication interface may include a short-range communication interface (e.g., a Bluetooth communication interface, a near field communication (“NFT”) interface, a Bluetooth Low Energy (“BLE”) communication interface, etc.), a mobile communication interface, etc. The initial power is a power for driving the communication interface, and may be, for example, a power of 100 watts (W) to 300 W. The communication interface operates to enable communication between the beverage extraction apparatus 1 and the power station 1000. The beverage extraction apparatus 1 may be paired with the power station 1000.

The reception coil 302 may receive power from the transmission coil 1001 of the power station 1000 after communication is established between the beverage extraction apparatus 1 and the power station 1000. The received power may be used to operate the beverage extraction apparatus 1. The received power used to operate the beverage extraction apparatus 1 may be higher than the initial power. For example, the received power may be a power higher than 800 W, but is not limited thereto. The received power may be used to operate the heater 11, the pump 12, and other components of the beverage extraction apparatus 1.

Moreover, while in the embodiment of the disclosure, it has been described mainly with respect to an example in which the beverage extraction apparatus 1 is used to extract coffee, the use of the beverage extraction apparatus 1 is not necessarily limited to the coffee. For example, the beverage extraction apparatus 1 according to the embodiment of the disclosure may be used to extract a beverage other than coffee, such as tea, in a manner similar to coffee extraction.

Although reference has been made to embodiments of the disclosure illustrated in the drawings for understanding the disclosure, and specific terms have been used to describe the embodiments thereof, the scope of the disclosure is not limited by the specific terms, and the disclosure will be construed to encompass all embodiments that would normally occur to one of ordinary skill in the art.

Particular implementations described herein merely correspond to embodiments of the disclosure and do not limit the scope of the disclosure in any way. For the sake of brevity of the specification, conventional electronic configurations, control systems, software, and other functional aspects of the systems may be omitted. Furthermore, connecting lines or connectors shown in various figures are intended to represent exemplary functional connections and/or physical or logical couplings between components in the figures, and in an actual device, connections between components may be represented by many alternative or additional functional relationships, physical connections, or logical connections. In addition, an element may not be necessarily essential to the practice of the disclosure unless the element is specifically described as essential,” “critical,” etc. As used herein, the term such as “comprising”, “including” and the like are used to be understood as being an open-ended term for describing embodiments of the disclosure.

The use of the terms “a”, “an”, “the” and similar referents in the context of describing the disclosure (especially in the context of the following claims) are to be construed to cover both the singular and the plural. Furthermore, recitation of ranges of values herein are merely intended to serve as a shorthand method of referring individually to each separate value falling within the range (unless otherwise indicated herein), and each separate value is incorporated into the specification as if it were individually recited herein. Lastly, operations of methods according to the disclosure described herein may be performed in any suitable order unless clearly specified herein or contradicted by context. The disclosure is not limited to the described order of the operations. The use of any and all examples or exemplary language, e.g., “such as”, etc., provided herein is merely intended to describe the disclosure in detail and does not pose a limitation on the scope of the disclosure unless otherwise limited by the claims. Furthermore, various changes and modifications will be readily apparent to one of ordinary skill in the art without departing from the spirit and scope of the disclosure.

A beverage extraction apparatus according to an embodiment of the disclosure may be an apparatus for extracting a beverage by discharging heated water toward a dripper.

According to an embodiment of the disclosure, the beverage extraction apparatus include a water tank for storing water, a heater for heating the water supplied from the water tank, and a water distribution module configured to discharge the heated water toward the dripper from a plurality of locations.

According to an embodiment of the disclosure, the water distribution module of the beverage extraction apparatus includes a pipe member for providing at least one flow path for receiving the heated water, and a water outlet member including a water outlet plate and a plurality of water outlets provided to pass through the water outlet plate.

The water distribution module may be configured such that discharge times at which water begins to be discharged from the plurality of water outlets are different.

In the water outlet member, lengths of water discharge through the plurality of water outlets, diameters of the plurality of water outlets, lengths of paths along which water moves to the plurality of water outlets, or protrusion heights of the plurality of water outlets may be different such that the discharge times for the plurality of water outlets are different.

The plurality of water outlets may have different thicknesses along a direction in which the water is discharged therefrom so that the lengths of water discharge vary.

Thicknesses of at least some of the plurality of water outlets may be greater than a thickness of the water outlet plate.

At least some of the plurality of water outlets may have different diameters.

At least some of the plurality of water outlets may have different protrusion heights from a reference surface in a direction opposite to the direction in which the water is discharged.

The plurality of water outlets may include a plurality of peripheral water outlets spaced apart from a center of the water outlet member, and the water outlet plate may further include a guide wall that guides a flow path of water along a top surface of a central region of the water outlet plate such that paths along which water supplied from the pipe member moves toward the plurality of peripheral water outlets, respectively, have different lengths.

The water outlet member may further include a blade configured to rotate and provided in an upper portion of the water outlet plate, and the blade may include a wing configured to be rotated by water supplied through the pipe member, and a body portion fixed to the wing to rotate together when the wing rotates and including a discharge opening through which water is discharged toward some of the plurality of water outlets.

The water outlet plate may have a partition wall provided to separate the plurality of water outlets from each other.

The pipe member may include a first pipe supplying water to a central region of the water outlet plate and a plurality of second pipes supplying water to an outer region of the water outlet plate, and the plurality of water outlets may include a plurality of drip water outlets provided in the central region and a plurality of rinsing water outlets provided in the outer region.

A beverage extraction apparatus according to an embodiment of the disclosure is an apparatus for extracting a beverage by discharging heated water toward a dripper.

According to an embodiment of the disclosure, the beverage extraction apparatus include a water tank for storing water, a heater heating the water supplied from the water tank, and a water distribution module configured to discharge the heated water toward the dripper from a plurality of locations.

According to an embodiment of the disclosure, the water distribution module of the beverage extraction apparatus may include a pipe member providing at least one flow path for receiving the heated water, and a water outlet member including a water outlet plate and a plurality of water outlets provided to pass through the water outlet plate.

The water distribution module may be configured such that at least one of diameters of the plurality of water outlets or lengths of paths along which water supplied from the pipe member moves until it is discharged through the plurality of water outlets is different.

The plurality of water outlets may include a plurality of main water outlets spaced apart along an imaginary straight line passing through a center of the water outlet member, and a plurality of auxiliary water outlets that are equidistant radially from the center of the water outlet member, and a diameter of each of the main water outlets may be greater than a diameter of each of the auxiliary water outlets.

In the water outlet member, lengths of water discharge through the plurality of water outlets, the diameters of the plurality of water outlets, the lengths of paths along which water moves to the plurality of water outlets, or protrusion heights of the plurality of water outlets may be different such that discharge times at which the water is discharged through the plurality of water outlets are different.

The water outlet member may further include a blade configured to rotate and provided in an upper portion of the water outlet plate, and the blade may include a wing configured to be rotated by water supplied through the pipe member, and a body portion fixed to the wing to rotate together when the wing rotates and including a discharge opening through which water is discharged toward some of the plurality of water outlets.

The pipe member may include a first pipe for supplying water to a central region of the water outlet plate and a plurality of second pipes for supplying water to an outer region of the water outlet plate, and the plurality of water outlets may include a plurality of drip water outlets provided in the central region and a plurality of rinsing water outlets provided in the outer region.

What is claimed is:

1. A beverage extraction apparatus (1) for extracting a beverage by discharging heated water toward a dripper (2), the beverage extraction apparatus comprising:
a water tank (20) configured to store water;
a heater (11) configured to heat the water supplied from the water tank; and
a water distribution module (100) configured to discharge the heated water toward the dripper from a plurality of locations,
wherein the water distribution module (100) comprises:
a pipe member (110) configured to provide at least one flow path for receiving the heated water and
a water outlet member (200) including a water outlet plate (210) and a plurality of water outlets (220, 230) provided to pass through the water outlet plate,
wherein the water distribution module is configured such that discharge times at which water begins to be discharged from the plurality of water outlets are different.

2. The beverage extraction apparatus of claim 1, wherein, in the water outlet member (200), at least one of lengths of water discharge through the plurality of water outlets, diameters of the plurality of water outlets, lengths of paths along which water moves to the plurality of water outlets, or protrusion heights of the plurality of water outlets are different such that the discharge times for the plurality of water outlets is different.

3. The beverage extraction apparatus of claim 2, wherein thicknesses of the plurality of water outlets (230) vary along a direction in which the water is discharged therefrom so that the lengths of water discharge vary.

4. The beverage extraction apparatus of claim 3, wherein thicknesses of at least some of the plurality of water outlets are greater than a thickness of the water outlet plate.

5. The beverage extraction apparatus of claim 2, wherein diameters of at least some of the plurality of water outlets are different from one another.

6. The beverage extraction apparatus of claim 2, wherein protrusion heights of at least some of the plurality of water outlets from a reference surface in a direction opposite to a direction in which the water is discharged are different from one another.

7. The beverage extraction apparatus of claim 1, wherein
the plurality of water outlets (230) comprises a plurality of peripheral water outlets (232) spaced apart from a center of the water outlet member, and
the water outlet plate further comprises a guide wall (215) configured to guide a flow path of water along a top surface of a central region (211) of the water outlet plate such that lengths of paths along which the water supplied from the pipe member moves toward the plurality of peripheral water outlets, respectively, are different.

8. The beverage extraction apparatus of claim 1, wherein
the water outlet member further comprises a blade (240) configured to rotate and provided in an upper portion of the water outlet plate, and
the blade (240) comprises:
a wing (241) configured to be rotated by the water supplied through the pipe member, and
a body portion (242) fixed to the wing to rotate together when the wing rotates and including a discharge opening (244) through which water is discharged toward some of the plurality of water outlets.

9. The beverage extraction apparatus of claim 8, wherein the water outlet plate includes a partition wall (216) provided to separate the plurality of water outlets from each other.

10. The beverage extraction apparatus of claim 1, wherein
the pipe member comprises a first pipe (111) configured to supply water to a central region (211) of the water outlet plate and a plurality of second pipes (112) configured to supply water to an outer region (212) of the water outlet plate, and
the plurality of water outlets includes a plurality of drip water outlets (230) provided in the central region and a plurality of rinsing water outlets (220) provided in the outer region.

11. A beverage extraction apparatus for extracting a beverage by discharging heated water toward a dripper, the beverage extraction apparatus comprising:
a water tank configured to store water;
a heater configured to heat the water supplied from the water tank; and
a water distribution module configured to discharge the heated water toward the dripper from a plurality of locations,
wherein the water distribution module comprises:
a pipe member configured to provide at least one flow path for receiving the heated water and
a water outlet member including a water outlet plate and a plurality of water outlets provided to pass through the water outlet plate,
wherein the water distribution module is configured such that at least one of diameters of the plurality of water outlets or lengths of paths along which water supplied from the pipe member moves until it is discharged through the plurality of water outlets is different.

12. The beverage extraction apparatus of claim 11, wherein the plurality of water outlets comprises a plurality of main water outlets (233) spaced apart along an imaginary straight line passing through a center of the water outlet member, and a plurality of auxiliary water outlets (234) that are equidistant radially from the center of the water outlet member, and a diameter of each of the plurality of main water outlets is greater than a diameter of each of the plurality of auxiliary water outlets.

13. The beverage extraction apparatus of claim 11, wherein, in the water outlet member, lengths of water discharge through the plurality of water outlets, the diameters of the plurality of water outlets, the lengths of paths along which water moves to the plurality of water outlets, or protrusion heights of the plurality of water outlets are different such that discharge times at which the water is discharged through the plurality of water outlets are different.

14. The beverage extraction apparatus of claim 11, wherein
the water outlet member further comprises a blade configured to rotate and provided in an upper portion of the water outlet plate, and
the blade comprises:
a wing configured to be rotated by the water supplied through the pipe member, and
a body portion fixed to the wing to rotate together when the wing rotates and including a discharge opening through which water is discharged toward some of the plurality of water outlets.

15. The beverage extraction apparatus of claim 11, wherein
the pipe member comprises a first pipe configured to supply water to a central region of the water outlet plate and a plurality of second pipes configured to supply water to an outer region of the water outlet plate, and
the plurality of water outlets includes a plurality of drip water outlets provided in the central region and a plurality of rinsing water outlets provided in the outer region.

16. The beverage extraction apparatus of claim 1, wherein the plurality of water outlets includes a central water outlet (231) provided at a center of the water outlet plate and a plurality of peripheral water outlets (232) provided around the central water outlet,
wherein the discharge time at the central water outlet is earlier than the discharge times at the plurality of peripheral water outlets.

17. The beverage extraction apparatus of claim 16, wherein water is discharged from the plurality of peripheral water outlets sequentially in a clockwise or counter-clockwise direction.

18. The beverage extraction apparatus of claim 8, wherein the water outlet plate includes a rotation-support shaft that supports the blade to be rotatable with respect to the water outlet plate.

19. The beverage extraction apparatus of claim 9, wherein the partition wall is provided in plural, two adjacent partition walls among the plurality of partition walls form a channel (218) that extends toward a center of the water outlet plate.

20. The beverage extraction apparatus of claim 10, wherein the water outlet plate further includes a border wall (213) between the central region and the outer region to separate the central region from the outer region.
